(19) United States
(12) Patent Application Publication
(10) Pub. No.: US 2002/0024999 A1
(43) Pub. Date: Feb. 28, 2002

(54) Video encoding apparatus and method and recording medium storing programs for executing the method

(76) Inventors: Noboru Yamaguchi, Yashio-shi (JP); Rieko Furukawa, Toyama-shi (JP); Yoshihiro Kikuchi, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/925,567

(22) Filed: Aug. 10, 2001

(30) Foreign Application Priority Data
Aug. 11, 2000 (JP) 2000-245026

(51) Int. Cl. H04N 7/12

(52) U.S. Cl. 375/240.03; 375/240.08; 375/240.01; 375/240.12; 375/240.16

(57) ABSTRACT

A video encoding apparatus comprises a first computing device that computes a statistical feature amount of a video image for each frame, a scene divider that divides the video image into a plurality of scenes in accordance with the statistical feature amount, a second computing device that computes an average feature amount for each sense, a scene selector that selects the scenes, a generator that generates an encoding parameter including an optimum frame rate and quantization step size for each scene, and an encoder that encodes the input video signal in accordance with the encoding parameter.

### CROSS-REFERENCE TO RELATED APPLICATIONS

This application is based upon and claims the benefit of priority from the prior Japanese Patent Application No. 2000-245026, filed Aug. 11, 2000, the entire feature of which are incorporated herein by reference.

### BACKGROUND OF THE INVENTION

1. Field of the Invention

The present invention pertains to a video compression encoding apparatus in accordance with an MPEG scheme or the like for use in a video transmission system or a picture database system via Internet or the like. More particularly, the present invention relates to a video encoding apparatus and a video encoding method for carrying out encoding in accordance with encoding parameters corresponding to the feature of a scene by means of a technique called as two-pass encoding.

2. Description of the Related Art

Conventionally, it has been well known that MPEG1 (Motion Picture Experts Group-1), MPEG2 (Motion Picture Experts Group-2), and MPEG4 (Motion Picture Experts Group-4) are provided as an international standard scheme for video encoding for practical use. In these schemes, an MC+DCT scheme is employed as a basic encoding scheme.

A conventional video encoding scheme based on the MPEG scheme carries out processing called as rate control for setting encoding parameters such as frame rate or quantization step size so as to be obtained as a value obtained when a bit rate of an encoding bit stream to be outputted, thereby carrying out encoding in order to transmit compression video data by means of a transmission channel in which a transmission rate is specified or in order to record the video data in a storage medium with its limited record capacity.

In many rate controls, there is employed a method for determining an interval up to a next frame and a quantization step size of the next frame according to an amount of coded bits in a previous frame.

Therefore, in a scene in which a large screen motion causes an increased number of generated bits, control is provided in a direction in which the quantization step size is increased in order to cope with an increased number of generated bits.

On the other hand, in rate control, a frame rate is determined based on a difference (tolerance) between a buffer size of preset frame skip threshold and a current buffer level. When the current buffer is smaller than the threshold, encoding is conducted at a constant frame rate. When the current buffer exceeds the threshold, control is conducted so as to reduce the frame rate.

As a result of such control, in a frame with a large number of generated bits, there occurs a phenomenon that a frame rate is reduced, and frames with equal intervals are increased in frame intervals. Namely, frame skipping occurs.

This is because the conventional rate control defines an amount of coded bits in a next frame irrespective of the feature of a video image. Thus, in a scene in which a screen movement is larger, there has been a problem that an unnatural picture motion occurs due to an excessively wide frame interval or that a picture is degraded due to an improper quantization step size, making the picture hardly visible.

Therefore, there is a need to solve such a problem, and some techniques are already known for that purpose. Apart from a scheme in which rate control is conducted by means of a method called as two-pass encoding among them, many of the others primarily include a method in which attention is paid to only change in number of generated bits. Considering a relationship between video feature and the amount of coded bits has been limited to a special case such as fade-in fade-out, for example.

Because of this, the inventors proposed a video encoding method and apparatus for distributing a bit rate according to the analyzed scene feature, and efficiently distributing encoding parameters so as to meet a bit rate at which the entire bit rate has been specified in advance.

In addition, there is proposed a video editing system in which the scene feature is analyzed, and a headline representing photographer's intention relevant to a video image every scene is automatically created and presented, thereby making it possible for even general persons to easily edit the video image (Reference 5: Hori et al, “GUI for Video Image Media Utilized Video Image Analysis Technique”, Human Interface 72-7 pp. 37 to 42, 1997). However, in this editing system, the scene feature was not reflected in encoding.

On the other hand, in the case where encoding data is generated for storage media, a video image is edited in advance in this editing system, and is encoded. Conventionally, even if the result of an edit operation is utilized for encoding, cutting points during editing has been considered.

As described above, in a conventional video encoding apparatus, a frame rate or a quantization step size has been determined irrespective of the feature of a video image. Thus, there has been a problem that image quality degradation is likely to be outstanding such as rapid reduction of a frame rate in a scene in which an object motion is severe or image degradation because of its improper quantization step size.

In addition, cut & paste or the like is carried out by using a personal computer or the like, and a video signal is edited so as to obtain a desired video image story so as to complete a video image. Even if the scene feature is grasped in this edit operation, there is not provided a system of utilizing such information when a video signal is encoded. Therefore, bit rate distribution has been wasteful.

It is an object of the present invention to provide a video encoding method and a video editing method utilizing the scene feature for edit operation and properly distributing a bit rate according to the scene feature, the video editing method being capable of efficiently distributing encoding parameters so as to meet a bit rate at which an entire bit rate has been specified in advance.

### BRIEF SUMMARY OF THE INVENTION

According to a first aspect of the invention, there is provided a video encoding apparatus for encoding a video image comprising: a first feature amount computing device configured to compute a statistical feature amount for each frame of the video image by analyzing an input video signal representing the video image; a scene dividing device configured to divide the video image into a plurality of scenes each including a frame or continuous frames in accordance with the statistical feature amount; a second feature amount computing device configured to compute an average feature amount for each of the senses using the feature amount obtained by the first feature amount computing device; a scene selector configured to select a part of the scenes or all of the scenes; an encoding parameter generator configured to generate an encoding parameter including at least an optimum frame rate and quantization step size for each of the scenes using the feature amount of the scene selected by the scene selector; and an encoder configured to encode the input video signal in accordance with the encoding parameter generated for each of the scenes by the encoding parameter generator.

According to a second aspect of the invention, three is provided a video encoding method comprising: computing a statistical feature amount every frame by analyzing an input video signal; dividing a video image into scenes each formed of a frame or continuous frames in accordance with the statistical feature amount; computing an average feature amount for each of the senses, using the statistical feature amount; selecting a part of the scenes or all of the scenes; generating an encoding parameter including at least an optimum frame rate and quantization step size for each of the scenes, using the feature amount of each scene selected; and encoding the input video signal in accordance with the encoding parameter generated for each of the scenes.

According to a third aspect of the invention, there is provided a computer program stored on a computer readable medium, comprising: instruction means for instructing a computer to compute a statistical feature amount every frame by analyzing an input video signal; instruction means for instructing the computer to divide a video image into scenes each formed of a frame or continuous frames in accordance with the statistical feature amount; instruction means for instructing the computer to compute an average feature amount for each of the senses, using the statistical feature amount; instruction means for instructing the computer to select a part of the scenes or all of the scenes; instruction means for instructing the computer to generate an encoding parameter including at least an optimum frame rate and quantization step size for each of the scenes, using the feature amount of each scene selected; and instruction means for instructing the computer to encode the input video signal in accordance with the encoding parameter generated for each of the scenes.

### BRIEF DESCRIPTION OF THE SEVERAL VIEWS OF THE DRAWING

FIG. 1 is a block diagram depicting a configuration of a video encoding apparatus according to one embodiment of the present invention;

FIG. 2 is a view illustrating a display example of a structured information providing device of the video encoding apparatus according to one embodiment of the present invention;

FIG. 3 is an illustrative view of partially selecting an encoding scene;

FIG. 4 is a block diagram depicting an exemplary configuration of an optimum parameter computing device in a system according to the present invention;

FIGS. 5A and 5B are views showing an example of procedures for scene division in accordance with one embodiment of the present invention;

FIGS. 6A to 6E are views illustrating classification of frame type based on a motion vector in accordance with one embodiment of the present invention;

FIG. 7 is a view illustrating judgment of a macro-block in which a mosquito noise is likely to occur in a system according to the present invention;

FIGS. 8A and 8B are views showing procedures for adjusting an amount of coded bits in a system according to the present invention;

FIG. 9 is a view showing a change in an amount of coded bits concerning I picture in a system according to the embodiment of the present invention;

FIG. 10 is a view showing a change in an amount of coded bits concerning P picture in a system according to the present invention;

FIGS. 11A and 11B are views comparing a change between a bit rate and a frame rate in a system according to the present invention with a conventional method; and

FIG. 12 is a view showing an example of MPEG bit streams.

### DETAILED DESCRIPTION OF THE INVENTION

According to the present invention, in encoding a video image signal, parameters are optimized in a first pass (an optimization preparation mode), and encoding process is effected by using the optimized parameters in a second pass (an execution mode). Specifically, an input video image signal is first divided in a scene including frames that are continuous in time, a statistical feature amount is computed every scene, and the scene feature is estimated based on this statistical feature amount. The scene feature is utilized for edit operation. Even if a scene cut and paste occurs due to editing, optimum encoding parameters are determined relevant to a target bit rate by utilizing a relative relationship in statistical feature amount every scene. This is first pass processing. In the second pass, an input video image signal is encoded by employing these encoding parameters. In this manner, even the data sizes are the same, a visible decoding image can be obtained.

Hereinafter, embodiments of the present invention will be described with reference to the accompanying drawings.

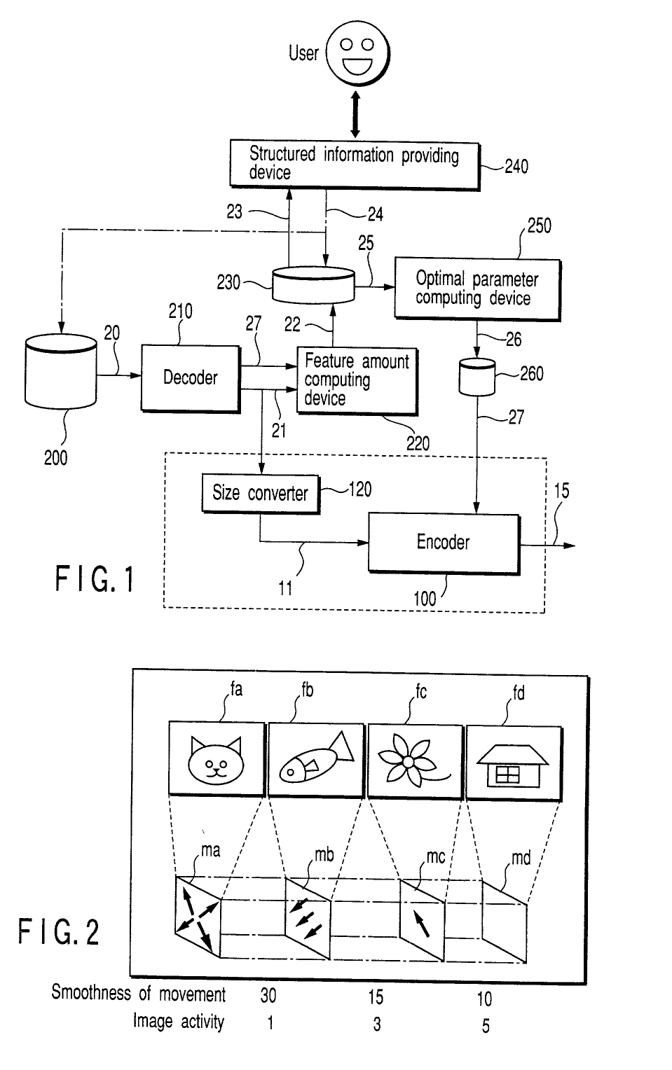

FIG. 1 is a block diagram depicting a configuration of a video editing/encoding apparatus according to one embodiment of the present invention. In the figure, at the video editing/encoding apparatus, there are provided an encoder 100, a size converter 120, source data 200, a decoder 210, a feature amount computing device 220, a structured information storage device 230, a structured information providing device 240, an optimum parameter computing device 250, and an optimum parameter storage device 260.

From among these elements, the encoder 100 is provided to encode and output a video image signal provided via the size converter 120. This encoder encodes a video image signal by employing parameters (information on optimum frame rate and quantization step size for each scene) stored in the optimum parameter storage device 260.

The decoder 210 corresponds to a format of inputted source data 200, and reproduces an original video image signal by decoding the source data 200 inputted via a signal line 20. The video image signal reproduced by this decoder 210 is supplied to the feature amount computing device 220 and the size converter 120 via a signal line 21.

The source data 200 is video image data recorded in a video recorder/player device such as digital VTR or DVD system capable of reproducing identical signals a plurality of times.

The feature amount computing device 220 has a function for carrying out scene division for a video image signal provided from the decoder 210, and at the same time, computing an image feature amount relevant to each frame of a video image signal. The image feature amount used here includes the number of motion vectors, distribution, norm size, residual error after motion compensation, variance of luminance and chrominance or the like, for example. The feature amount computing device 220 is configured so as to count the computed feature amounts and respective frame images of scenes every divided scene, and supply them to the structured information storage device 230 via the signal line 22.

The structured information storage device 230 stores information on key-frame images of each scene or feature amount as information structured for each scene. In the case where the size of a key-frame image is large, the reduced image (thumb nail image) may be stored instead of such frame image.

The structured information providing device 240 is a main-machine interface that has at least an input device such as keyboard and a pointing device such as mouse, and has a display. This device carries out various operational inputs or instructive inputs including edit operation employing an input device or receives the key-frame image and feature amount of each scene stored in the structured information storage device 230, whereby these image and feature amount are displayed on a display in a providing manner as shown in FIG. 2, and the feature of a video image signal are provided to a user.

In a system according to the present invention, in processing of a second pass, a video image signal supplied via the signal line 21 is a video signal obtained by means of the decoder 210 reproducing source data edited corresponding to edit information supplied from the structured information providing device 240 via the signal line 24.

The size converter 120 carries out processing for converting the screen size of a video image signal supplied via the signal line 21 and the screen size if the screen sizes of video image signals encoded and outputted by means of the encoder 100 differ from each other. The encoder 100 receives an output of this size converter 120 via a signal line 11, and carries out encoding process.

In addition, an optimum parameter computing device 250 receives supply of information on a feature amount provided from the structured information storage device 230 via a signal line 25, and computes the optimum frame rate and quantization step size relevant to each scene. For information on a feature amount read out from the structured information storage device 230, the structured information storage device 230 is configured to read out and supply information on a feature amount of the corresponding scene in accordance with edit information from the structured information providing device 240 supplied via the signal line 24.

In addition, the optimum parameter storage device 260 is provided to store information on an optimum frame rate and quantization step size for each scene computed by this optimum parameter computing device 250.

Now, an operation of the thus configured system will be described here. A system according to the present invention is a scheme that first carries out first pass processing (optimization preparation mode), and then, carries out second pass processing (execution mode). Thus, in this system, a video recorder/player device such as digital VTR or DVD system capable of repeatedly reproducing and supplying identical video image signals many times is employed, data recorded in this video recorder/player device is reproduced, the reproduced data is supplied as source data 200 to the decoder 210 via the signal line 20.

The decoder 210 which has received source data 200 from this video recorder/player device decodes the source data, and outputs the data as a video image signal. Then, the video image signal reproduced by means of this decoder 210 is supplied to the feature amount computing device 220 via the signal line 21 in the first pass.

The feature amount computing device 220 first carries out scene division of a video image signal by employing this video image signal. This device computes an image feature amount relevant to each frame of the video image signal at the same time. The image feature amount used here includes the number of motion vectors, distribution, norm size, residual error after motion compensation, variance of luminance and chrominance or the like, for example.

Then, the feature amount computing device 220 compiles the key-frame image of a scene and such computed feature amount for each divided scene, and supplies these image and amount to the structured information storage device 230 via the signal line 22.

Then, the structured information storage device 230 stores these items of information. As a result, in the first pass, the structured information storage device 230 stores information structured for each scene, the information being obtained by analyzing a supplied video image signal. In storing the key-frame image of each divided scene, in the case where the size of the key-frame image is large, the reduction image (thumb nail image) may be stored instead of the frame image.

In this way, when the feature amount of each scene of the video image signal and the key-frame image are stored in the structured information storage device 230, the structured information storage device 230 then reads out the key-frame image or feature amount of each scene stored, and supplies them to the structured information providing device 240 via the signal line 23. The structured information providing device 240 which has received them provides the feature of a video image signal to a user in a providing manner as shown in FIG. 2.

An example shown in FIG. 2 is disclosed in Reference 5 described previously. The key-frame images “fa”, “fb”, “fc”, and “fd” of each scene and content information (symbols) “ma”, “mb”, “mc”, and “md” on motions of these respective images “fa”, “fb”, “fc”, and “fd” are provided to a user by displaying them on a screen, whereby the feature of each scene can be easily reminded by the user.

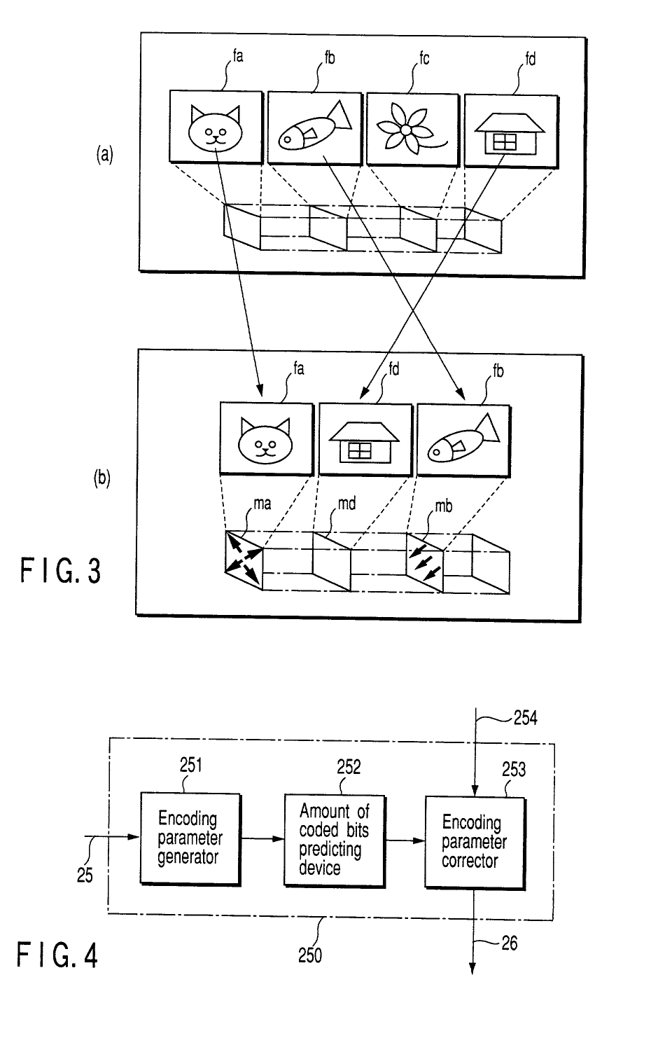

The structured information providing device 240 comprises a video image edit function for making a cut & paste operation or a drag & drop operation for a key-frame image, thereby making it possible to freely perform edit operations such as position movement, scene deletion, or copy. Therefore, as described above, the key-frame image and structured information on a video image signal are provided to a user, thereby making it possible for the user to easily grasp the feature of a video image signal. In addition, as shown in FIG. 3, edit operation such as scene cut & paste can be easily carried out. Of course, it is possible to provide structured information on a plurality of video image signals to the user and edit them.

An example of FIG. 3 originally shows that the following feature is edited. That is, a key-frame “fc” is cut relevant to the display form of FIG. 2 disposed as (a) in FIG. 3, the key-frames “fc” and “fd” are exchanged with each other, a scene represented by the key-frame “fd” follows that represented by the key-frame “fa”, and then, a scene represented by the key-frame “fb” is displayed ((b) in FIG. 3).

For example, the edit information thus edited by the user edit operation is supplied to the structured information storage device 230 and source data 200 via the signal line 24. The edit information used here includes information on which scene has been selected or information on time stamps in source data 200 on the thus selected scene or scene disposition after edited.

When the user carries out editing as described above by using the structured information providing device 240, the information is supplied as edit information to the structured information storage device 230 via the signal line 24. Then, the structured information storage device 230 stores this edit information, and at the same time, assigns the information to an optimum parameter computing device 250.

The optimum parameter computing device 250 receives supply of information of a feature amount of the corresponding scene stored in the structured information storage device 230, computes the optimum frame rate and quantization step size relevant to each scene, and assigns them to the optimum parameter storage device 260. In this manner, the optimum parameter storage device 260 stores information on the optimum frame rate and quantization step size for each scene.

A specific example of the optimum parameter computing device 250 will be described with reference to FIG. 4.

<Configuration of an Optimal Parameter Computing Device 250>

This optimum parameter computing device 250 receives a feature amount of the corresponding scene from the structured information storage device 230, and computes the optimum frame rate and quantization step size relevant to each scene in accordance with edit information assigned from the structured information providing device 240 by the user making edit operation of the structured information device 240. The optimum parameter computing device 250, as shown in FIG. 4, comprises an encoding parameter generator 251, a bit generation quantity predicting device 252, and an encoding parameter corrector 253.

Among these elements, the encoding parameter generator 251 computes the frame rate and quantization step size suitable to each scene from a relative relationship of the feature amount of each scene, based on the feature amount received from the structured information storage device 230. The bit generation quantity predicting device 252 predicts an amount of coded bits when a video image signal is encoded based on the frame rate and quantization step size computed by means of this encoding parameter generator 251.

In addition, the encoding parameter corrector 253 is provided to correct parameters, wherein parameters are corrected so that the predicted amount of coded bits meets the amount of coded bits set by the user, thereby obtaining optimum parameters.

In the thus configured optimum parameter computing device 250, with respect to the feature amount of each scene supplied from the structured information storage device 230 via the signal line 25, the frame rate and quantization step size suitable to each scene is computed from a relative relationship of the feature amount of each scene by means of the encoding parameter generator 251. Then, the bit generation quantity predicting device 252 predicts an amount of coded bits when a video image signal is encoded based on the thus computed frame rate and quantization step size while these frame rate and quantization step size are defined as inputs.

At this time, in the case where the predicted number of generated bits remarkably differs from the target amount of coded bits 254 set by the user, the encoding parameter corrector 253 corrects parameters so that the thus predicted amount of coded bits meets the amount of coded bits set by the user, thereby obtaining an optimum parameter.

As described above, the first pass processing is carried out as follows. That is, a video image signal is reproduced, the information on the feature amount of each scene and a key-frame image are obtained and stored. When edit operation of a video image signal is made by employing these information and image, the feature amount of the corresponding scene is read out in accordance with the edit information. Then, by employing the read out amount, the optimum frame rate and quantization step size suitable to each scene is computed, and the computed information is stored as parameters.

When the first pass processing terminates, the user operates the structured information providing device 240, thereby switching mode into an execution mode, i.e., a processing mode in the second pass. Then, the structured information providing device 240 generates a command for driving a system so as to encode a video image signal by means of an encoder 100 by employing information on the optimum frame rate and quantization step size of each scene stored in the optimum parameter storage device 260.

In this manner, a system starts second pass processing (execution mode).

In the second pass processing, the video image signal supplied via the signal line 21 is a video image signal obtained when edited source data obtained by editing source data 200 is reproduced by means of the decoder 210 based on edit information supplied via the signal line 24.

This video image signal is sent to the encoder 100, and encoded by employing optimum parameters corresponding to the scene stored in the optimum parameter storage device 260 for each scene. As a result, the encoder 100 outputs a bit stream 15 in which the amount of coded bits is properly distributed according to the feature of a scene.

In this way, in the second pass processing, a video image signal supplied via the signal line 21 is encoded by means of the encoder 100. For such encoding, optimum parameters stored in the optimum parameter storage device 260 is employed, thereby generating a bit stream in which the amount of coded bits is properly distributed according to the feature of a scene. As a result, a video image is analyzed, and the feature of a scene is utilized for edit operation. In addition, a bit rate is distributed according to the feature of a scene, and video image encoding for efficiently distributing encoding parameters can be carried out so that the entire bit rate meets a predetermined bit rate, and no skip is generated. In addition, there can be provided an encoding method capable of obtaining a decoded image that is visible even in the same data size.

In the second pass, in the case where the screen size of a video image signal supplied via the signal line 21 differs from the screen size when encoded by means of the encoder 100, the screen size is converted at the size converter 120, and then, the video image signal is supplied to the encoder 100 via the signal line 11. In this manner, a problem caused by an unmatched screen size does not occur.

Now, individual processing at the feature amount computing device 220 in a system according to the present embodiment will be described in more detail. The subjects of image feature amount computation processing at the feature amount computing device 220 for computing an image feature amount include: processing for scene division relevant to an inputted video image signal; and processing for computing the motion vector of a macro-block in a frame and a residual error after motion compensation and the average and variance of luminance value with respect to all the frames of inputted video image signals. In addition, the image feature amount includes a motion vector and a residual error after motion compensation of a macro-block in a frame and the average and variance of luminescence values or the like.

<Scene Division Processing at a Feature Amount Computing Device>

At the feature amount computing device 220, an inputted video image signal 21 is divided into a plurality of scenes other than frames such as flash frame or noise frame due to a difference between the adjacent frames. The flash frame used here denotes a frame in which luminescence rapidly increases at a moment when flash (strobe) light-emits at an interview scene in a news program, for example. In addition, the noise frame denotes a frame in which an image quality is significantly degraded due to camera swinging or the like.

For example, scene division is carried out as follows.

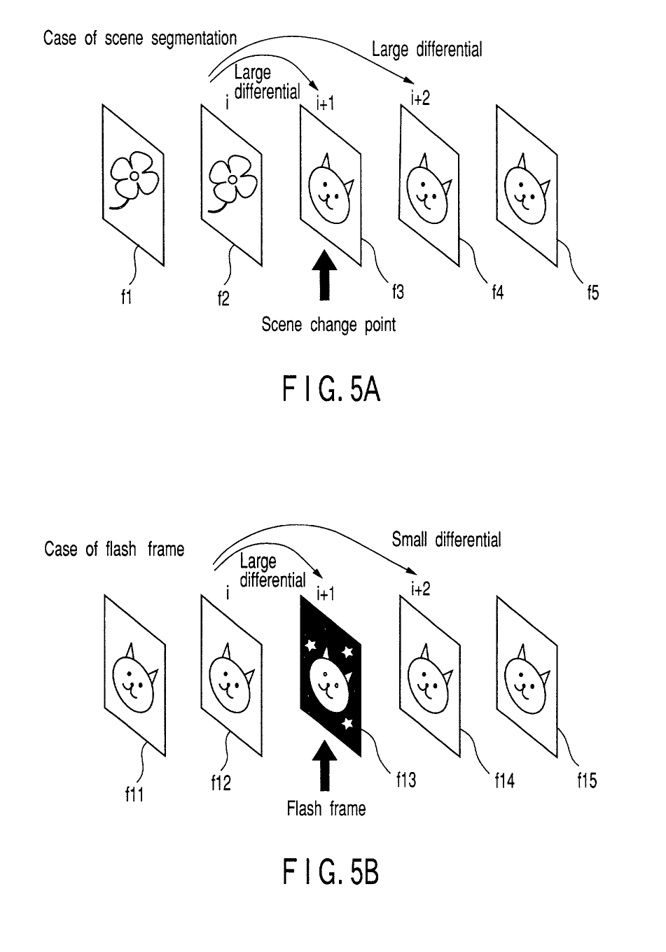

As shown in FIGS. 5A and 5B, if a difference value between an “i”-th frame and an (i+1)-th frame exceeds a predetermined threshold, and a difference value between the “i”-th frame and an (i+2)-th frame exceeds the threshold similarly, it is determined that the (i+1)-th frame is a segment of a scene.

Even if a difference value between the “i”-th frame and the (i+1)-th frame exceeds the predetermined threshold, when a difference value between the “i”-th frame and the (i+2)-th frame does not exceed the threshold, the (i+1)-th frame is not determined as a segment of a scene.

<Computation of Motion Vector at a Feature Amount Computing Device>

Apart from processing for scene division as described above, the feature amount computing device 220 computes a motion vector of a macro-block in a frame and a residual error after motion compensation and the average and variance of luminance values or the like relevant to all the frames of the inputted video image signals 21. The feature amount may be computed relevant to all the frames or may be computed by several frames in a range in which image properties can be analyzed.

Assume that the number of macro-blocks in a motion region relevant to the “i”-th frame is defined as “MvNum (i)”, a residual error after motion compensation is defined as “MeSad (i)”, and the variance of luminance values is defined as “Yvar (i)”. Here, the motion region denotes a region of a macro-block that is a motion vector from the previous frame in one frame which is not 0. The average values of MvNum (i), MeSad (i), and Yvar (i) of all the frames included in that scene are defined as Mvnum_j, MeSad_j, and Yvar_j, and these values are representative values of the feature amount of j-th scene.

<Scene Classification Processing at a Feature Amount Computing Device>

Further, in the present embodiment, the feature amount computing device 220 carries out the following scene classification by employing a motion vector, and predicts the feature of a scene.

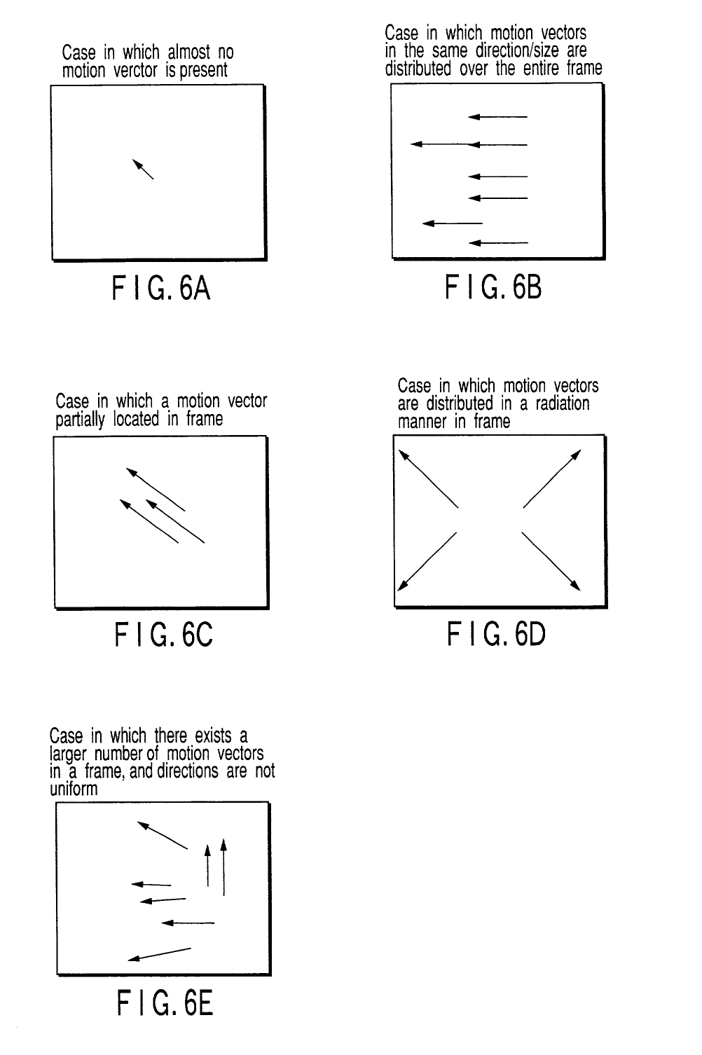

That is, after the motion vector has been computed relevant to each frame, the distribution of motion vectors is investigated, and scenes are classified. Specifically, the distribution of motion vectors in a frame is computed, and it is checked which of five type shown in FIGS. 6A to 6D each frame belongs to.

Type [1]: A type shown in FIG. 6A and a type of which almost no motion vector exists in a frame (when the number of macro-blocks in a motion region is Mmin or less).

Type [2]: A type shown in FIG. 6B and a type of which motion vectors with their identical directions and sizes are distributed over the entire frame (when the number of macro-blocks in a motion region is Mmax or more, and the size and direction are within a predetermined range).

Type [3]: A type shown in FIG. 6C and a type of which a motion vector appears at a specific portion in a frame (when the macro-blocks in a motion region are positioned intensively at a specific portion).

Type [4]: A type shown in FIG. 6D and a type of which motion vectors are distributed in a radiation manner in a frame.

Type [5]: A type shown in FIG. 6D and a type of which a large number of motion vectors are present in a frame, and their directions are not uniform.

Any of the patterns of these types [1] to [5] are closely related to a camera used when a video image signal targeted for processing is obtained or a movement of an object in an acquired image. That is, in the pattern of type [1], both of the camera and object enter a static state. In addition, the pattern of type [2] is obtained in the case where an object moves on the static background during camera parallel movement. In addition, the pattern of type [4] is obtained in the case where the camera carries out zooming. In addition, the pattern of type [5] is obtained in the case where the camera and object move altogether.

As has been described above, the classification result for each frame is summarized for each scene. and it is determined which of the types shown FIGS. 6A to 6E a scene belongs to. By employing the type of the determined scene and the computed feature amount, the frame rate and bit rate that are encoding parameters are determined for each scene at the encoding parameter generator described later.

In this way, the feature amount computing device 220 carries out scene classification by employing a motion vector, and predicts the feature of a scene.

Now, a detailed description will be given with respect to individual processing when encoding parameters are generated at the encoding parameter generator 251 that is one of the structure elements of the optimum parameter computing device 250.

The encoding parameter generator 251 carries out four types of processing, i.e., (i) processing for computing a frame rate; (ii) processing for computing a quantization step size; (iii) processing for correcting the frame rate and quantization step size; and (iv) processing for setting the quantization step size for each macro-block. In this manner, encoding parameters such as frame rate, quantization step size, and quantization step size for each macro-block are generated.

<Processing for Computing a Frame Rate at an Encoded Parameter Generator>

The encoding parameter generator 251 first computes a frame rate. At this time, assume that the previously described feature amount computing device 220 has already computed the representative value of the feature amount of each scene. In contrast, the frate rate FR (j) of a j-th scene is computed in accordance with formula (1) below

FR(j)=a×MVnum_j+b+w_FR (1)

where MV num_j denotes a representative value of a j-th scene, “a” and “b” each denote a coefficient related to a user specified bit rate and image size, and W_FR denotes a weighting parameter described later. Formula (1) means that the representative value MVnum_j of the motion vector ER(j), the higher the frame rate. That is, a scene including a larger movement increases a frame rate.

In addition, as the representative value MV num_of a motion vector, there may be employed an absolute sum and density of the sizes of motion vectors in a frame other than the number of motion vectors in the previously described frame.

A description of frame rate computation processing at the encoding parameter generator 251 has now been completed.

<Processing for Computing a Quantization Width at an Encoded Parameter Generator>

In computing a quantization step size, the encoding parameter generator 251 computes a frame rate relevant to each scene, and then, computes a quantization step size relevant to each scene. Like a frame rate FR (j), the quantization step size Qp (j) relevant to a j-th scene is computed by employing a representative value MVnum_j of a motion vector of a scene in accordance with formula (2) below.

Qp(j)=c×MVnum_j+d+v+w_Qp (2)

where “c” and “d” each denotes a coefficient relevant to a user specified bit rate and image size, and w_Qp denotes a weighting parameter described later.

Formula (2) denotes that an increase in representative value of a motion vector MVnum_j causes an increase in quantization step size QP (j). That is, a scene including a large motion increases a quantization step size. Conversely, a scene including a small motion decreases a quantization step size, and an clearer and sharper image is produced.

<Correction of a Frame Rate and a Quantization Width at an Encoded Parameter Generator>

At the encoding parameter generator 251, in correcting a frame rate and a quantization step size, when the frame rate and quantization step size are determined by employing formulas (1) and (2), the classification result of a scene obtained by the above described scene classification processing (type of frame configuring a scene) is employed to add a weighting parameter w_RF to formula (1) and a weighting parameter w_QP to formula (2) and correct the frame rate and quantization step size.

Specifically, in the case of type [1] of which almost no motion vector exists in a frame (in FIG. 6A), a frame rate is reduced, and a quantization step size is reduced (w_FR and w_Qp are reduced altogether).

In type [2] as shown in FIG. 6B, a frame rate is increased so as to prevent a camera movement from being unnatural, and the quantization step size is increased (w_FR and w_Qp are increased altogether).

In type [3] as shown in FIG. 6C, in the case where a motion of an object in action, i.e., the size of a motion vector is large, a frame rate is corrected (WFR is increased).

In type [4] as shown in FIG. 6D, almost no attention is deemed to be paid to an object during zooming. Thus, a quantization step size is increased, and a frame rate is increased to its required maximum (w_FR and w_Qp are increased altogether).

In type [5] as shown in FIG. 6E as well, a frame rate is increased, and a quantization step size is increased (w_jR and w_Qp are increased altogether).

The thus set weighting parameters w_FR and w_Qp are added, respectively, whereby a frame rate and a quantization step size are adjusted.

Processing for correcting a frame rate and a quantization step size at the encoding parameter generator 251 is as follows.

As a mechanism for maintaining an image quality, the encoding parameter generator 251 is capable of changing a quantization step size in units of macro-blocks specified by a user ((iv) processing for setting a quantization step size of each macro-block). Namely, the quantization step size is changed in units of macro-blocks. A detailed description of such processing will be described here.

<Setting a Quantization Width for each Macro-block at an Encoded Parameter Generator>

In a system according to the present invention, the encoding parameter generator 251 can function so as to vary a quantization step size in units of macro-blocks when this device receives an instruction for changing the quantization step size for each macro-block.

In MPEG-4 as well, although an image is divided into blocks with 16×16 pixels, and processing is advanced in units of blocks, these block units are called as a macro-block. At the encoding parameter generator 251, in the case where a user specifies that a quantization step size is changed for each macro-block, the quantization step size is set to be smaller than that of another macro-block relevant to a macro-block in which it is determined that a strong edge exists such as macro-block or telop characters in which it is determined that a mosquito noise is likely to occur in a frame.

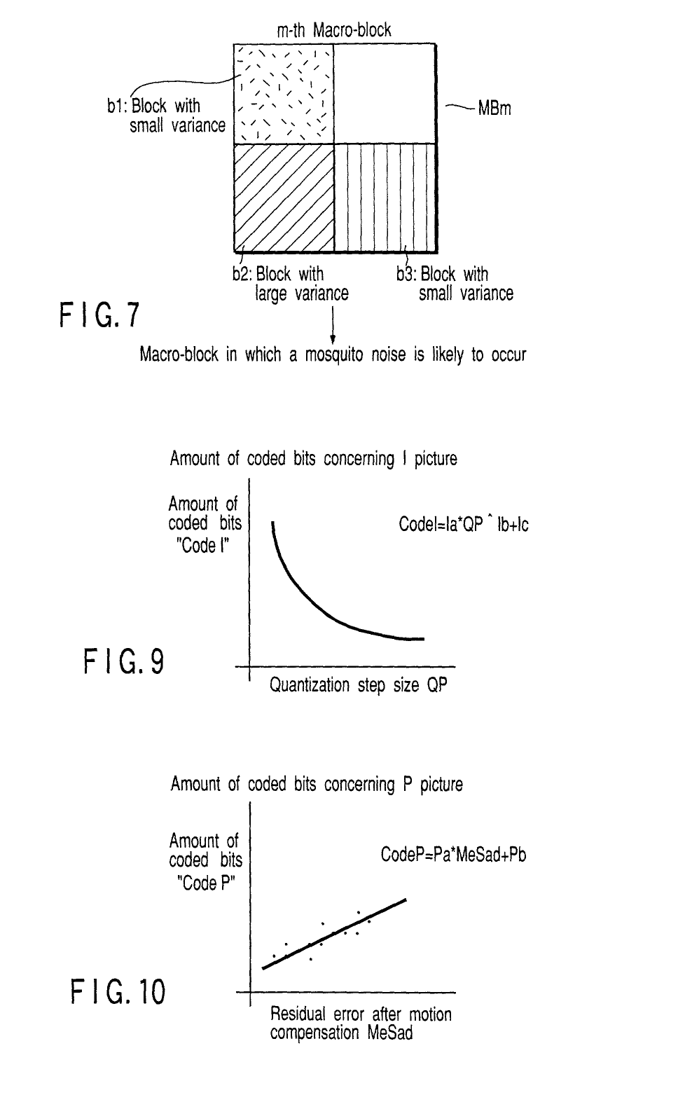

With respect to a frame targeted for encoding, as shown in FIG. 7, the variance of luminescence values is computed for each small block obtained by further dividing the macro-block MBm into four sections. At this time, in the case where a micro-block (b2) with a large variance of luminance values is adjacent to a micro-block (b1, b3) with a small variance, if a quantization step size is large, a mosquito noise is likely to occur in such a macro-block MBm. That is, when a portion in which a texture is flat is adjacent to a portion in which a texture is complicated in the macro-block, a mosquito noise is likely to occur.

Because of this, a case in which a micro-block with a small variance is adjacent to a micro-block with a large variance of luminance values is determined for each macro-block. with respect to a macro-block in which it is determined that a mosquito noise is likely to occur, a quantization step size is set to be relatively smaller than that of another macro-block. Conversely, with respect to a macro-block in which it is determined that a texture is flat and a mosquito noise is unlikely to occur, a quantization step size is set to be relatively larger than that of another macro-block so as to prevent an increased number of generated bits.

For example, with respect to an m-th macro-block in a j-th frame, when four micro-blocks exist in such macro-block, as shown in FIG. 7, if there exists a micro-block which meets a combination of (variance of block “k”)≧MB VarTre 1 and (variance of blocks adjacent to block “k”)<MB VarThre 2 (3), it is determined that this m-th macro-block is a macro-block in which a mosquito noise is likely to occur (MB VarThre 1 and MB VarThre 2 are user defined thresholds). With respect to such m-th macro-block, the quantization step size Qp(j)_m of the macro-block is reduced in accordance with formula (4).

QP(j)_m=QP(j)−q1 (4)

In contrast, with respect to an m′-th macro-block in which it is determined that a mosquito noise is unlikely to occur, a quantization step size QpC)_m′ of a macro-block is increased in accordance with formula (5) below, thereby preventing an increased amount of coded bits.

QpC)_m=QpC)+q2 (5)

where q1 and q2 each denote a positive number, and meets QpC)−q1≧(minimum value of quantization step size) and QpO)+q2≦(maximum value of quantization step size).

At this time, with respect to a scene determined to be a parallel movement scene shown in FIG. 6B, a scene of camera zooming shown in FIG. 6D in the above camera parameter determination, such a scene depends on a camera movement. Thus, it is considered that low visual attention is paid to an object in an image. Therefore, q1 and 12 are reduced.

Conversely, in a still scene shown in FIG. 6A or in a scene in which moving portions shown in FIG. 6C are present intensively, it is considered that high visual attention is paid to an object in an image. Therefore, q1 and q2 are increased.

In addition, with respect to a macro-block in which a character-like edge exists as well, a quantization step size is reduced, thereby making it possible to clarify a character portion. An edge emphasis filter is applied to data on frame luminance values so as to check a pixel for each macro-block in which an edge gradient is strong. Pixel positions are counted, and it is determined that blocks in which pixels with large gradients are partially intensive are macro-blocks in which an edge exists. Then, the quantization step size for such block is reduced in accordance with formula (4), and the quantization step size of the other macro-block is increased in accordance with formula (5).

In this way, the quantization step size is changed in units of macro-blocks, thereby making it possible to ensure a mechanism capable of assuring an image quality.

The detailed description has now been completed with respect to four types of processing, i.e., (i) processing for computing a frame rate, (ii) processing for computing a quantization step size, (iii) processing for correcting the frame rate and quantization step size; and (iv) processing for setting the quantization step size of each macro-block, to be carried out in generating encoding parameters at the encoding parameter generator 251.

Now, a detailed description will be given with respect to processing at the encoding parameter corrector 253 for correcting the thus computed, encoding parameters so as to meet a user specified bit rate.

<Predicting the Number of Generated Bits at an Encoded Parameter Corrector>

The number of generated bits is predicted at the encoding parameter corrector 253 as follows.

If encoding is carried out by employing the frame rate and quantization step size of each scene computed as described above by means of the encoding parameter generator 251, a scene bit rate may exceed the upper limit or lower limit of an allowable bit rate. Because of this, a parameter of a scene exceeding the limit is adjusted, thereby making it necessary to set the parameter within the upper limit or lower limit.

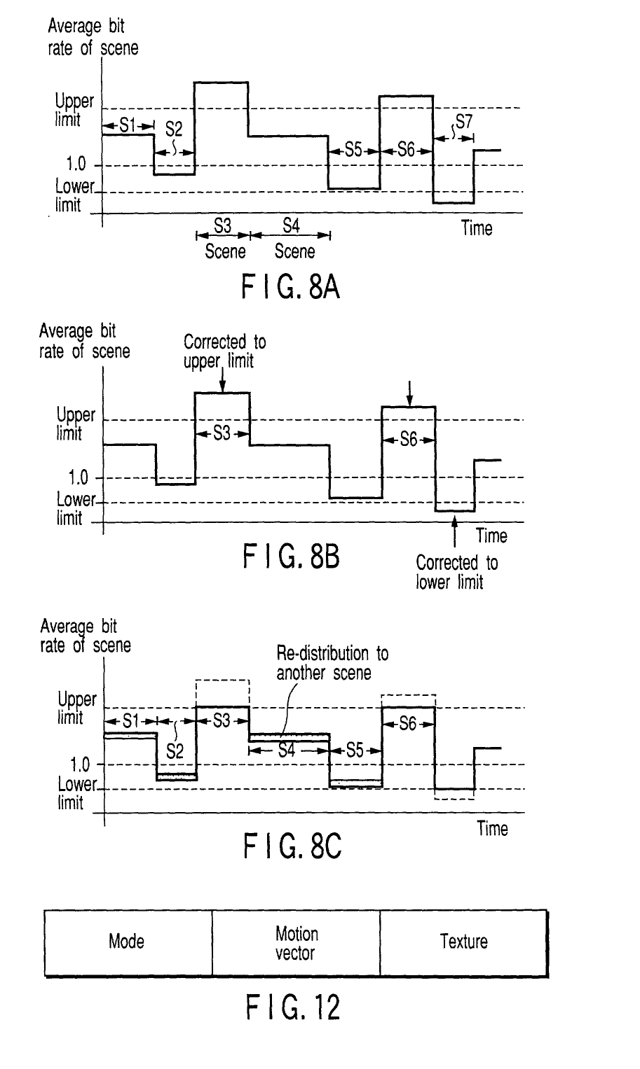

For example, when encoding is carried out with the frame rate and quantization step size of the computed, encoding parameters, and the bit rate of each scene to the user set bit rate is computed, a scene (S3, S6, S7) may be produced such that the upper limit or lower limit of the bit rate is exceeded as shown in FIG. 8A.

Because of this, in the present invention, the following processing is carried out by means of the encoding parameter corrector 253, and a correction process is applied such that the bit rate of each scene does not exceed the upper limit or lower limit of an allowable bit rate.

That is, when the user computes a rate to the user set bit rate, in a scene (S3, S6) such that the upper limit of a bit rate is exceeded, as shown in FIG. 8B, the bit rate is reset to the upper limit. Similarly, in a scene (S7) in which the lower limit of a bit rate is exceeded, as shown in FIG. 8B, the bit rate is reset to the lower limit.

The amount of coded bits that is exceeded or insufficient by this operation is re-distributed into another scene that has not been corrected as shown in FIG. 8C, and operation is made so that the entire amount of coded bits is not changed.

It is required to predict an amount of coded bits for that purpose. Here, an amount of coded bits is predicted as follows, for example.

The encoding parameter corrector 253 assumes that the first frame of each scene is defined as I picture, and the other frame is defined as P picture, and computes the amount of coded bits, respectively. First, an amount of coded bits for I picture is estimated. With respect to an amount of coded bits for I picture, a relationship as shown in FIG. 9 is generally established between the quantization step size QP and the amount of coded bits. Thus, an amount of coded bits per frame “Code I” is computed as follows, for example.

Code I=Ia×QPˆ Ib+Ic (6)

where Ia, Ib, and Ic each denote a constant defined depending on an image size or the like, and ˆ denotes an exponent.

Further, with respect to a P picture, a relationship shown in FIG. 10 is substantially established between a residual error after motion compensation “MeSad” and the amount of coded bits. Thus, an amount of coded bits per frame “Code P” is computed as follows.

Code P=Pa×MeSad+Pb (7)

where Pa and Pb each denote a constant defined by an image size, a quantization step size Qp or the like. In an image feature amount computing device 220, the MeSad employed in formula (7) is assumed as having been already obtained. From these formulas, the rate in amount of coded bits generated for each scene is computed. The number of generated bits in a J-th scene is obtained as follows.

Code(j)=Code I+(a sum of Code P in a frame to be encoded) (8)

When the amount of coded bits “Code (j) for each scene computed in accordance with the above formula is divided by a length T (j) of such a scene, an average bit rate BR (j) for such a scene is computed.

BR(j)=Code(j)/T(j) (9)

Encoded parameters are corrected based on the thus computed bit rate. In addition, in the case where the amount of coded bits predicted by correcting a bit rate as described above is substantially changed, the frame rate of each scene may be corrected. That is, a frame rate in a scene with its low bit rate is reduced, and a frame rate in a scene with its high bit rate is increased, thereby maintaining an image quality.

The detailed description of individual processing at the encoding parameter corrector 253 has now been completed.

As has been described above, according to the present invention, in encoding a video image signal, preliminary processing (first pass) for grasping and adjusting a state is conducted, and a two-step processing mode (second pass) for carrying out encoding by employing the obtained result is effected. With respect to a video image signal, first pass processing for obtaining the frame rate and bit rate of each scene is carried out, the frame rate and bit rate of each scene computed at the first pass are supplied to an encoder at the second pass, and a video image signal is encoded, thereby making it possible to carry out video image encoding free of frame skipping or image quality degradation. The encoder carries out encoding by employing conventional rate control while the target bit rate and frame rate are switched for each scene based on the encoding parameters obtained at the first pass. In addition, the macro-block quantization step size is changed relatively to the quantization step size computed by rate control by employing information on a macro-block obtained at the first pass. In this manner, a bit rate is maintained in one set of scenes, and thus, the size of the encoded bit stream can meet the target data size.

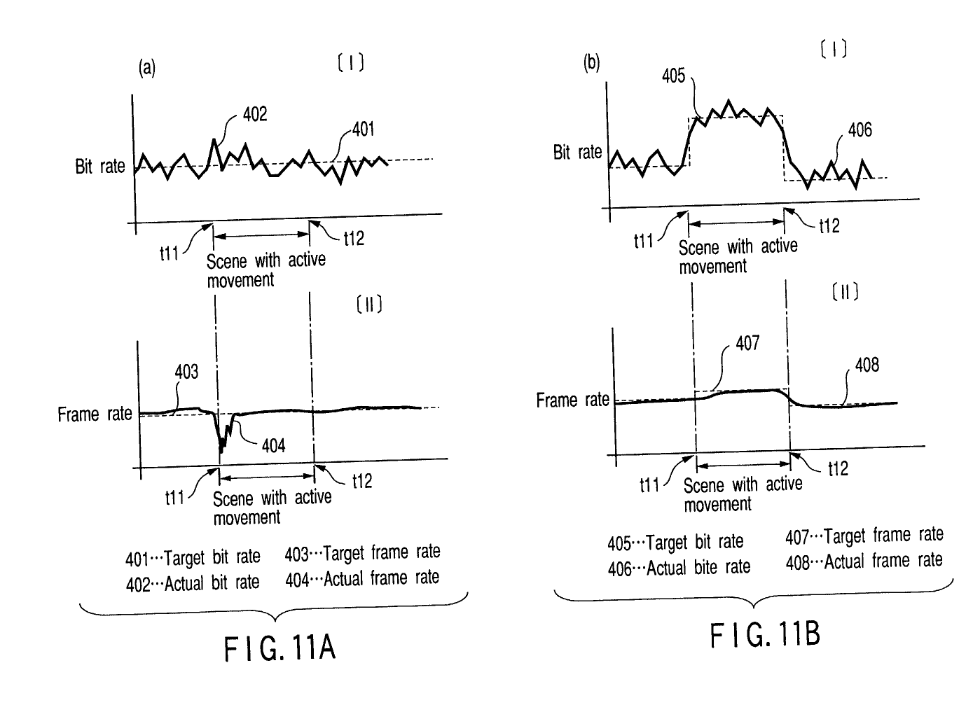

For the purpose of comparison, FIGS. 11A and 11B each show an example of change in bit rate and frame rate when encoding is carried out by employing a technique according to the present invention and a conventional technique.

FIG. 11A shows an example of change in bit rate and frame rate according to the conventional technique, and FIG. 11B shows an example of change in bit rate and frame rate according to a technique of the present invention.

In the conventional technique, as shown in [1] of FIG. 11A, a predetermined target bit rate 401 is defined. In contrast, as designated by reference numeral 403, a predetermined frame rate is set. In addition, as shown in [1] of FIG. 11B, the actual bit rate and frame rate are set as designated by reference numeral 402 (actual bit rate) and reference numeral 404 (actual frame rate). At this time, when a video image is changed to a scene with active movement (refer to intervals t11 to t12), an amount of coded bits rapidly increases in such a video image. Thus, a frame skip as shown in FIG. 15B occurs, and a frame rate is reduced, as designated by reference numeral 405 in [II] of FIG. 11B.

In contrast, in the technique (FIG. 11B) according to the present invention, a target bit rate is defined as designated by reference numeral 405 so as to obtain an optimum value according to a scene. In addition, a target frame rate is defined as designated by reference numeral 407 so as to obtain an optimum value according to a scene.

In this manner, when a video image is changed to a scene with an active movement, the target value changes according to the increased amount of coded bits. Thus, the bit rate assigned to such a scene is increased, and a frame skip is unlikely to occur. In addition, the frame rate can meet the target value.

Now, a description will be given with respect to an example when, in the case where source data is an MPEG stream (MPEG-2 stream in the case of DVD), an amount of first pass processing is reduced by partially reproducing only a required signal instead of reproducing all the bit streams at the first pass.

This exemplary configuration may be basically identical to that used in the first embodiment.

In the case where source data is an MPEG stream, a configuration of such bit stream is provided as shown in FIG. 12. As in an example shown in FIG. 12, the MPEG stream is roughly divided into mode information for switching intra-frame encoding/inter-frame encoding; motion vector information on inter-frame encoding; and texture information for reproducing a luminance or chrominance signal.

Here, in the case where a large number of blocks to be intra-frame encoded based on mode information, it is presumed that a scene change occurs. Thus, such blocks can be utilized for judgment of scene change point at the feature amount computing device 220 (refer to FIG. 1).

In addition, the MPEG stream includes motion vector information. Thus, the motion vector information contained in this MPEG stream is sampled so that the sampled information may be utilized at the feature amount computing device 220.

That is, the feature amount computing device 220 carries out processing for obtaining scene division of a video image signal and the image feature amount of such video image signal in each frame (number of motion vectors, distribution, norm size, residual error after motion compensation, variance of luminance/chrominance or the like). However, unlike the first embodiment, instead of obtaining all of these values by computation processing, it is known whether there exists a large or small number of blocks to be intra-frame encoded, scene change point is determined based on the above, and the current processing is substituted by scene division processing. In addition, information on a “motion vector” in the MPEG stream is sampled, and is used intact, thereby eliminating motion vector computation processing.

In this way, in the MPEG stream, without reproducing all data, processing can be simplified by utilizing the fact that data available at the feature amount computing device 220 by reproducing partial information can be acquired from among the MPEG stream.

In the case where such partially reproduced signal is utilized, the configuration shown in FIG. 1 is provided such that the above “model” information and “motion vector” information are acquired from among such partially reproduced signals, and these acquired items of information are supplied to the feature amount computing device 220 via the signal line 27. The feature amount computing device 220 is configured so as to carry out scene division processing by judging a scene segment from whether there exists a large or small number of blocks to be intra-frame encoded employing the “model”, information. This device is also configured so as to acquire the number of motion vectors by using information on “motion vector” in the MPEG stream intact. With respect to other computations (distribution of motion vectors, norm size, residual error after motion compensation, variance of luminance/chrominance or the like), there is employed a configuration in which processing similar to that of the first embodiment is done.

With such configuration, processing of the feature amount computing device 220 can be achieved as a configuration in which part of the processing is simplified.

As has been described above, according to the present invention, in encoding an image signal, parameters are optimized at the first pass (optimization preparation mode), and encoding is carried out by employing these optimized parameters at the second pass (execution mode).

That is, in the present invention, an inputted video image signal is first divided into a scene that includes at least one frame being continuous in respect of time. Then, the statistical feature amount (motion vector of macro-block in frame and residual error after motion compensation, and average and variance of luminance values) is computed for each scene, and the feature of each scene is estimated based on the statistical feature amount. The feature of the scene is utilized for edit operation. Even if cut & paste of a scene occurs due to editing, optimum encoding parameters are determined for a target bit rate by utilizing a relative relationship of the statistical feature amount of each scene. The present invention is basically characterized in that an input image signal is encoded by employing these encoding parameters, whereby a visible decoded image is obtained even in identical data sizes.

The statistical feature amount used here is computed for each scene by counting a motion vector or luminance value that exists in each frame of the inputted video image signal, for example. In addition, using the result obtained by estimating a movement of a camera used when an inputted video image signal is obtained from a specially small amount and a movement of an object in an image, these movements are reflected in encoding parameters. In addition, a distribution of luminance values is checked for each macro-block, whereby the quantization step size of a macro-block in which a mosquito noise is likely to occur or a macro-block in which an object edge exists is relatively reduced as compared with that of another macro-block, thereby improving an image quality.

In the second pass encoding, the bit rate and frame rate suitable to each computed scene are assigned, whereby encoding can be carried out according to the feature of a scene without significantly changing a conventional rate control mechanism.

By using the above two-pass technique, encoding for obtaining a good decoded image can be carried out in data size that is identical to the target amount of coded bits.

Techniques described in the embodiments of the present invention can be delivered as a program that can be executed by a computer in a manner in which these techniques are stored in a recording medium such as magnetic disk (such as flexible disk or hard disk), an optical disk (such as CD-ROM, CD-R, CD-RW, DVD, or MO), or semiconductor memory. In addition, these techniques can be delivered through transmission via a network.

As has been described above in detail, according to the present invention, a video image is analyzed, and the feature of a scene is utilized for edit operation. With respect to a new video image generated by such edit operation, optimum encoding parameters are computed from a relative relationship in statistical feature amount of each scene. Thus, edit operation is facilitated, a set of images can be obtained for each scene, and an effect of image quality improvement can be attained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video encoding apparatus for encoding a video image comprising:
a first feature amount computing device configured to compute a statistical feature amount for each frame of the video image by analyzing an input video signal representing the video image;
a scene dividing device configured to divide the video image into a plurality of scenes each including a frame or continuous frames in accordance with the statistical feature amount;
a second feature amount computing device configured to compute an average feature amount for each of the senses using the feature amount obtained by the first feature amount computing device;
a scene selector configured to select a part of the scenes or all of the scenes;
an encoding parameter generator configured to generate an encoding parameter including at least an optimum frame rate and quantization step size for each of the scenes using the feature amount of the scene selected by the scene selector; and
an encoder configured to encode the input video signal in accordance with the encoding parameter generated for each of the scenes by the encoding parameter generator.

2. An apparatus according to claim 1, wherein the scene selector is configured to select the scenes in accordance with operation information obtained by editing performed by an user.

3. An apparatus according to claim 2, which includes a scene content providing device configured to provide feature of each of the scenes to the user.

4. An apparatus according to claim 3, wherein the scene content providing device provides a key-frame of each scene or a thumb nail thereof to the user.

5. An Apparatus according to claim 3, wherein the scene content providing device provides a symbol indicating the feature amount or feature obtained for each scene by the second feature amount computing device to the user.

6. An apparatus according to claim 3, wherein the scene content providing device provides a key-frame of each scene or a thumb nail thereof and a symbol indicating the feature amount or feature obtained for each scene by the second feature amount computing device to the user.

7. An apparatus according to claim 1, wherein the feature amount includes at least some of the number of motion vectors, distribution, norm size, residual error after motion compensation, and variance of luminance and chrominance.

8. A video encoding method comprising:
computing a statistical feature amount every frame by analyzing an input video signal;
dividing a video image into scenes each formed of a frame or continuous frames in accordance with the statistical feature amount;
computing an average feature amount for each of the senses, using the statistical feature amount;
selecting a part of the scenes or all of the scenes;
generating an encoding parameter including at least an optimum frame rate and quantization step size for each of the scenes, using the feature amount of each scene selected; and
encoding the input video signal in accordance with the encoding parameter generated for each of the scenes.

9. A method according to claim 8, wherein the scene selecting step selects the scenes in editing performed by an user.

10. A method according to claim 9, which includes providing feature of each of the scenes to the user.

11. A method according to claim 10, wherein the scene content providing step provides a key-frame of each scene or a thumb nail thereof to the user.

12. A method according to claim 10, wherein the scene content providing step provides a symbol indicating the feature amount or feature obtained for each scene to the user.

13. A method according to claim 10, wherein the scene content providing device provides a key-frame of each scene or a thumb nail thereof and a symbol indicating the feature amount or feature obtained for each scene to the user.

14. A computer program stored on a computer readable medium, comprising:
instruction means for instructing a computer to compute a statistical feature amount every frame by analyzing an input video signal;
instruction means for instructing the computer to divide a video image into scenes each formed of a frame or continuous frames in accordance with the statistical feature amount;
instruction means for instructing the computer to compute an average feature amount for each of the senses, using the statistical feature amount;
instruction means for instructing the computer to select a part of the scenes or all of the scenes;
instruction means for instructing the computer to generate an encoding parameter including at least an optimum frame rate and quantization step size for each of the scenes, using the feature amount of each scene selected; and
instruction means for instructing the computer to encode the input video signal in accordance with the encoding parameter generated for each of the scenes.
